(19) United States
(12) Patent Application Publication
(10) Pub. No.: US 2016/0312963 A1
(43) Pub. Date: Oct. 27, 2016

(54) Color Temperature Adjusting Structure for LED Lamp

(71) Applicant: MODERN HOME LIGHTING INC., Dongguan City (CN)

(72) Inventor: Shih-Ming Lin, Dongguan City (CN)

(21) Appl. No.: 14/696,519

(22) Filed: Apr. 27, 2015

(51) Int. Cl. F21K 99/00

(52) U.S. Cl. CPC F21K 9/56

(57) ABSTRACT

A color temperature adjusting structure for an LED lamp contains: a lamp holder and at least one protective cover. The lamp holder has an LED light disc mounted thereon, and the at least one protective cover is made of translucent material and is covered on the LED light disc, wherein the translucent material is PE or PP. Accordingly, the color temperature adjusting structure is produced at lower cost, and a color temperature of the LED lamp is adjustable based on using requirement. Preferably, the at least one protective cover prevents dust, scald, electric shock, and mosquito.

### FIELD OF THE INVENTION

The present invention relates to a color temperature adjusting structure for an LED lamp which is produced at lower cost, and a color temperature of the LED lamp is adjustable based on using requirement.

### BACKGROUND OF THE INVENTION

A conventional tungsten light bulb has a color temperature at 2700 to 2400 K (i.e., warm light), a conventional fluorescent lamp has a color temperature at 5200 K (i.e., cold light), and a conventional LED lamp has a color temperature at 3000 K.

However, the conventional LED lamp is reduced its color temperature by increasing toner powder, thus causing high production cost.

The present invention has arisen to mitigate and/or obviate the afore-described disadvantages.

### SUMMARY OF THE INVENTION

The primary objective of the present invention is to provide a color temperature adjusting structure for an LED lamp which is produced at lower cost, and a color temperature of the LED lamp is adjustable based on using requirement.

Secondary objective of the present invention is to provide a color temperature adjusting structure for an LED lamp which prevents dust, scald, electric shock, and mosquito.

Another objective of the present invention is to provide a color temperature adjusting structure for an LED lamp which emits lights at a wide angle.

### BRIEF DESCRIPTION OF THE DRAWINGS

FIG. 1 is a perspective view showing the assembly of a color temperature adjusting structure for an LED lamp according to a first embodiment of the present invention.

FIG. 2 is a perspective view showing the exploded components of the color temperature adjusting structure for the LED lamp according to the first embodiment of the present invention.

FIG. 3 is a side plane view showing the assembly of the color temperature adjusting structure for the LED lamp according to the first embodiment of the present invention.

FIG. 4 is a side plane view showing the assembly of a color temperature adjusting structure for an LED lamp according to a second embodiment of the present invention.

FIG. 5 is a side plane view showing the assembly of a color temperature adjusting structure for an LED lamp according to a third embodiment of the present invention.

### DETAILED DESCRIPTION OF THE PREFERRED EMBODIMENTS

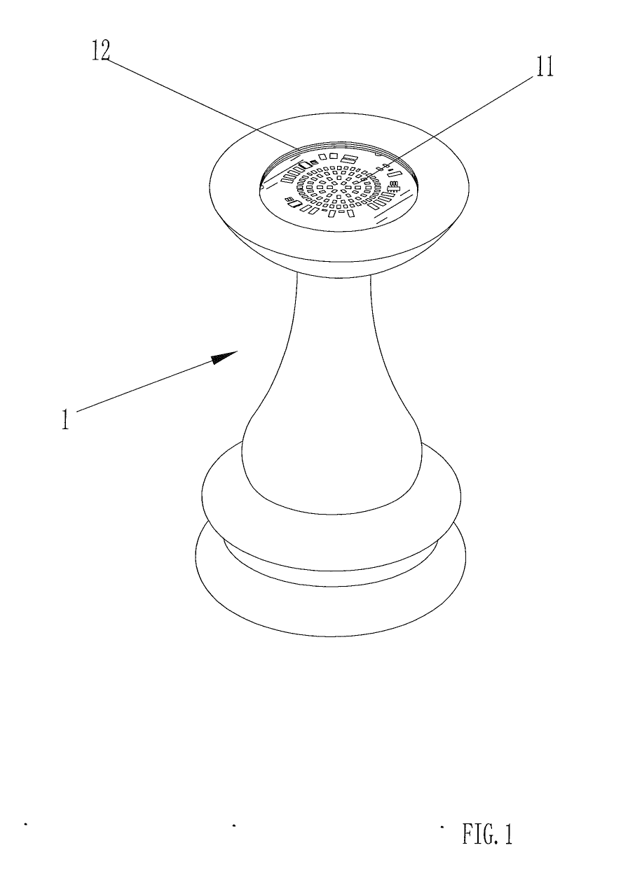

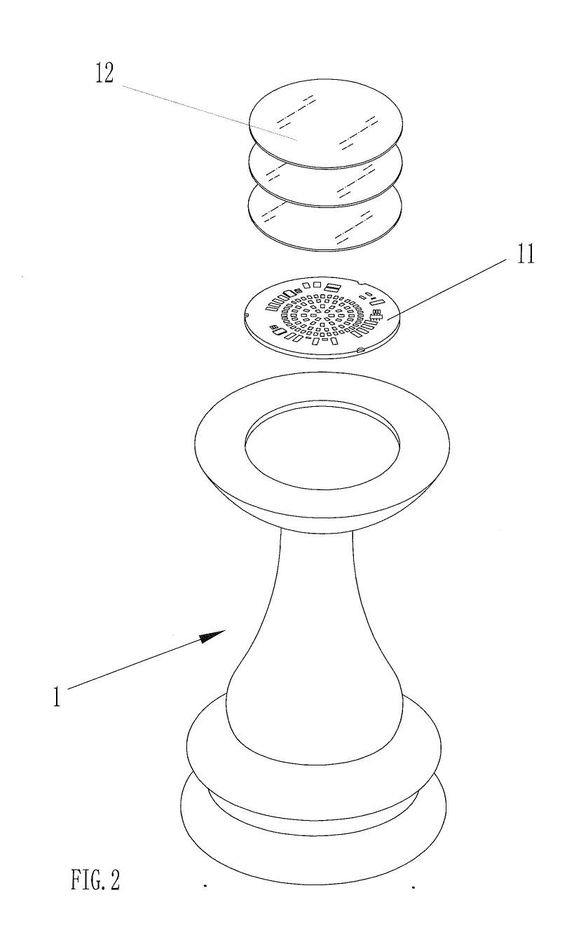

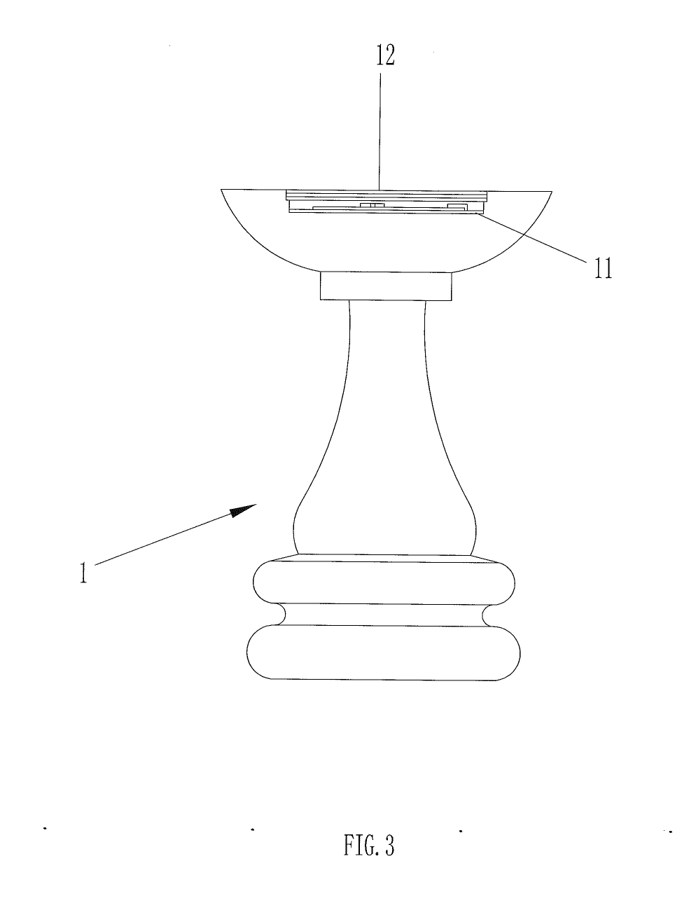

With reference to FIGS. 1 to 3, a color temperature adjusting structure for an LED lamp according to a first embodiment comprises:

a lamp holder 1 on which an LED light disc 11 is mounted; and

at least one protective cover 12 made of translucent material (such as PE or PP) and covered on the LED light disc 11.

In assembly, the LED light disc 11 is fixed on the lamp holder 1, and then the at least one protective cover 12 is covered on the LED light disc 11, such that when a number of the at least one protective cover is changed, a color temperature of the LED lamp is adjustable based on using requirement. For example, as a protective cover is covered on the LED light disc 11, the color temperature is reduced. In other words, the more the at least protective cover is, the higher the color temperature generates (i.e., the more the cold light occurs); and the less the at least protective cover is, the lower the color temperature generates (i.e., the more the warm light occurs).

Accordingly, the color temperature adjusting structure of the present invention is produced at lower cost, and the color temperature of the LED lamp is adjustable based on the using requirement. Preferably, the at least one protective cover prevents dust, scald, electric shock, and mosquito.

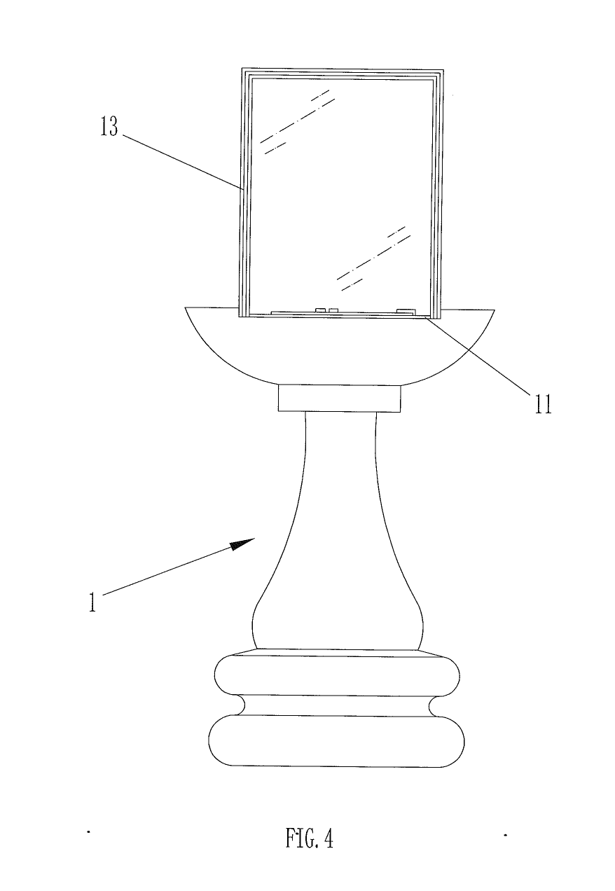

In a second embodiment, as shown in FIG. 4, a plurality of protective covers 13 are covered on the LED light disc 11, wherein each protective cover 13 is formed in a cup shape and has a flat top surface.

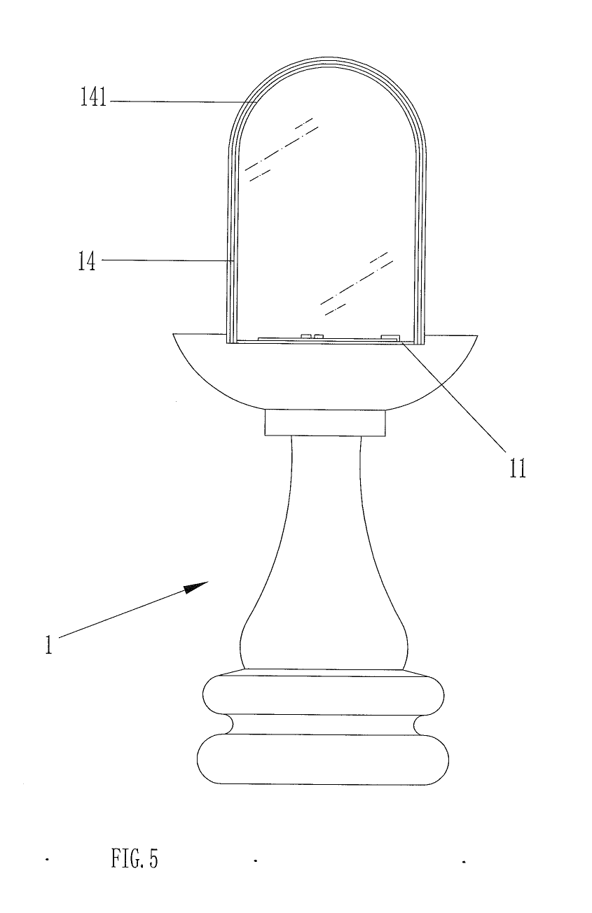

In a third embodiment, as illustrated in FIG. 5, a plurality of protective covers 14 are covered on the LED light disc 11, wherein each protective cover 14 is formed in a cup shape and has an arcuate top surface 141, thus emitting lights at a wide angle.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A color temperature adjusting structure for an LED lamp comprising:
a lamp holder on which an LED light disc is mounted; and
at least one protective cover made of translucent material and covered on the LED light disc;
wherein the translucent material is PE or PP.

2. The color temperature adjusting structure for the LED lamp as claimed in claim 1, wherein a plurality of protective covers are covered on the LED light disc, and each protective cover is formed in a cup shape and has a flat top surface.

3. The color temperature adjusting structure for the LED lamp as claimed in claim 1, wherein a plurality of protective covers are covered on the LED light disc, and each protective cover is formed in a cup shape and has an arcuate top surface.
